(19) United States
(12) Patent Application Publication
(10) Pub. No.: US 2001/0011028 A1
(43) Pub. Date: Aug. 2, 2001

(54) Electronic devices

(75) Inventor: Heino Wendelrup, Malmo (SE)

Correspondence Address: Gerald T. Welch, Jenkens & Gilchrist, P.C., 3200 Fountain Place, 1445 Ross Avenue, Dallas, TX, 75202-2799, US

(73) Assignee: TELEFONAKTIEBOLAGET LM ERICSSON

(21) Appl. No.: 09/772,621

(22) Filed: Jan. 30, 2001

(30) Foreign Application Priority Data
Feb. 1, 2000 (GB) 0002302.8

(51) Int. Cl. H04B 1/38

(52) U.S. Cl. 455/563; 455/550

(57) ABSTRACT

An electronic device has a plurality of user selectable operating modes. Each operating mode defining a set of operating parameters for the device. The device also has at least one voice activated function which is responsive to an input voice signal. The reference voice signals are stored in the device by a user of the device and are stored in groups, each of which relates to a specific operating mode of the telephone.

The present invention relates to electronic devices, and in particular to electronic communications devices having voice activated functions.

### BACKGROUND OF THE INVENTION

It is currently known to provide electronic devices such as mobile telephones with voice activated functions. For example, some mobile telephones make use of voice activated dialling (VAD) to simplify dialling of calls from the telephone.

FIG. 1 of the accompanying drawings schematically shows a device having a device controller 2 which controls various device functions 4. A digital signal processor (DSP) 8 is provided to receive voice inputs 10 from a user. The DSP 8 includes a voice comparison function 81 which compares the voice input 10 with voice signal data stored in DSP data storage 82. The output of the voice comparison function 81 serves to control the device functions 4, via the controller 2, in response to the received voice inputs. The DSP 8 receives the voice input 10 and compares it with entries in a user defined library of voice signals (or “voice tags”). The library of voice tags is received from device data storage 6 (particularly a voice tag data library area 62) whenever voice activation is selected. The DSP data storage 62 is also generally used to store data relating to other functions of the DSP 8, for example for use in noise reduction. Part of a library of voice tags for a voice activated dialling telephone is shown in FIG. 2. The telephone can be instructed to dial a telephone number simply by the user speaking the name of the person in the list. The voice tag data is stored by the user of the telephone.

The voice tag data library is transferred to the DSP each time voice activation is used. However, this requirement means that the number of voice tags that can be stored in the device is limited by speed, size and cost constraints of producing the DSP, since a large number of tags would take a long time (comparatively) to transfer between the device storage 6 and the DSP storage 8, and providing large memory in the DSP can add significantly to the size and cost of the DSP. A conventional voice tag data library typically stores around ten to fifteen voice tags.

Another feature of some electronic devices, most notably mobile telephones and mobile companions/organisers, is the provision of preferred operating modes in which groups of operating parameters of the device can be set simply by choosing the appropriate operating mode, or “profile”. For example, for a mobile telephone, different parameters can be set for use in a meeting compared to those required for use in a car. Examples of typical profiles for a mobile telephone are: Normal (default), Meeting, In Car, Outdoors, Portable Hands-free, and Home. Typical settings for the various profiles are shown in FIG. 3.

In the device shown in FIG. 1, data relating to the various operating modes are stored in a profiles data area 61 of the device data storage 6, and are recalled by the controller 2. The user of the device can choose when to change profile, or the profile can be changed automatically, for example by connection of accessories, or by reference to time or location.

### SUMMARY OF THE INVENTION

According to one aspect of the present invention, there is provided an electronic device comprising control means for providing the device with a plurality of selectable operating modes, the operating modes defining respective set of operating parameters for functions of the device, voice detection means for receiving an input voice signal and for providing voice activation of at least one function of the device, the voice detection means being operable to compare an input voice signal with a library of stored voice signals to determine the operation of the device corresponding to the input voice signal, wherein the stored voice signals are stored by the user of the device, and wherein each operating mode has a specific associated library of stored voice signals for use by the voice detection means when the operating mode concerned is selected.

### BRIEF DESCRIPTION OF THE DRAWINGS

FIG. 1 is a schematic diagram of a voice activated electronic device;

FIG. 2 illustrates part of a stored library of voice tags;

FIG. 3 illustrates various operating mode settings of a mobile telephone;

FIG. 4 is a schematic diagram of a storage element for use in a device in accordance with the present invention; and

FIG. 5 illustrates various operating mode settings of a mobile telephone embodying the present invention.

### DETAILED DESCRIPTION OF THE PREFERRED EMBODIMENT

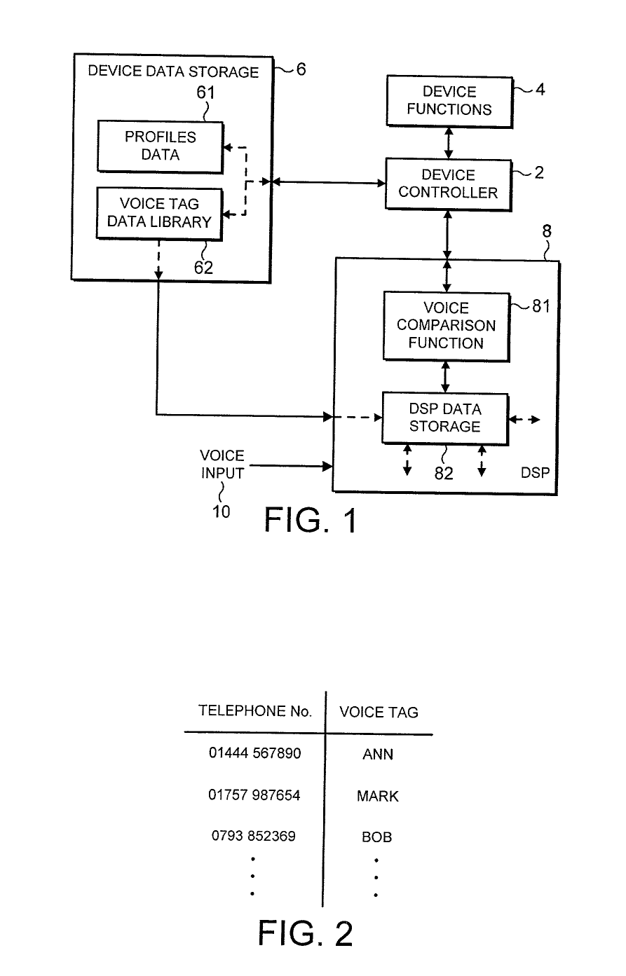

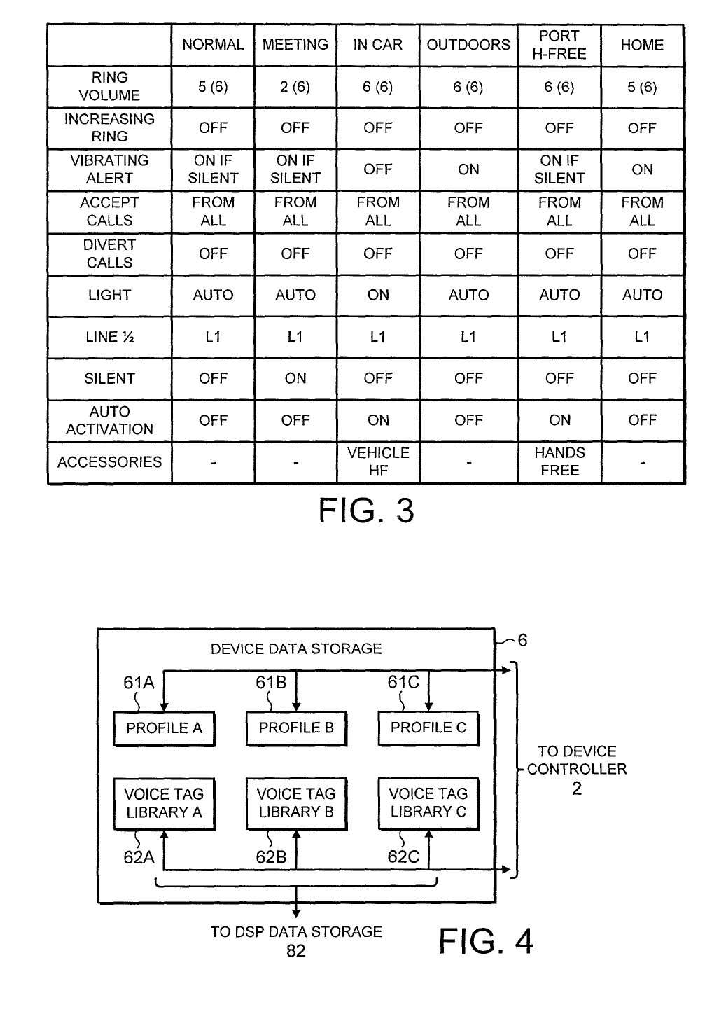

FIG. 4 of the accompanying drawings illustrates schematically a storage area for use in a device according to the invention. The device includes the other elements shown in FIG. 1, namely a device controller 2, which serves to control device functions 4, and a DSP 8. The device storage 6 includes areas for storing respective profile data (61A, 61B, 61C), relating to the different operating modes (A, B, C) of the device. As described above, the device controller 2 sets the operating parameters for the device functions 4 in accordance with the data stored in a selected profile data area 61A, 61B or 61C. For selected functions, the controller 2 is responsive to input signals from the DSP 8 in order to control the device in accordance with received voice signals.

As described above, the voice comparison function 81 of the DSP 8 operates to compare a voice input 10 with a stored voice tag data, and outputs to the controller an indication of the function to which the voice input relates.

In a device according to the present invention, the device data storage 6 includes additional storage areas for storing respective libraries of voice tags for use by the DSP 8. The device data storage 6 is not simply an enlarged voice tag storage area, since, as described above, the delay in voice processing caused by the use of such an external storage area would be too high to enable efficient voice activation of device functions.

In accordance with the present invention, the device data storage 6 is used for storing separate libraries 62A, 62B, 62C of voice tags, each library being associated with a respective profile (operating mode) of the device. Thus, when voice activation is selected, the voice tag library associated with the current profile is loaded into the DSP 8 for use in the voice activation of functions of the device. In this way, the effective number of voice tags that can be stored by the device can be increased without causing undue delays in voice processing. The libraries of tags are set up and stored by the user (or users) of the device.

Using the mobile telephone example, one profile could be used to define the use of the telephone for business purposes. In such a setting a specific business-oriented voice tag library can be used. This could contain, for example, business contact numbers. When the telephone is then switched to a home setting at the end of the day, the voice tag library is updated using a “home” library stored in the device data storage 6. This home library could contain, for example, contact numbers for family and friends. If necessary some names (spouse, boss etc.) can be stored in both lists. Alternatively, a single list of voice tags can be stored in the device data storage, with the voice tag library data selecting a number of entries from the list for use with a particular profile.

The following list illustrates possible uses for specific function related libraries, particularly with relation to mobile telephones. In each example two options are described but in reality the choice need not be limited to two and any or all of the options below may be combined. It will be readily appreciated that any of the functions on a mobile telephone might be voice activated, and that voice activated dialling is presented here merely as an example.

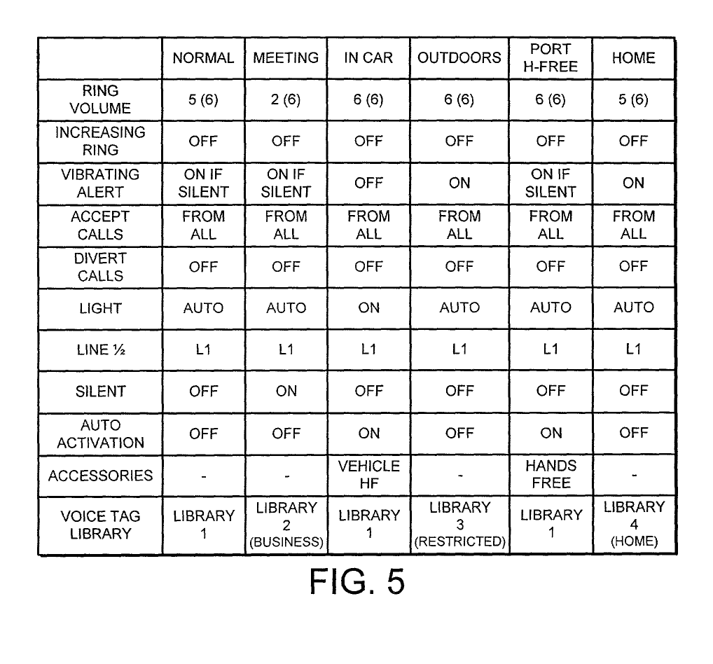

FIG. 5 illustrates various operating mode settings of a mobile telephone embodying the present invention, and it will be noted that each operating mode is specified with a particular voice tag library applicable to that mode of operation.

Work vs. Home

Different voice dialling lists can be used for the different modes, as described above.

Work vs. Car

In addition to selecting specific lists of voice tags for use in work and car, the profile can be used to reject incoming calls from specified people. The user may choose only to receive calls from people on the list associated with the Car Profile while driving. When using hands free mode in the car the phone can announce who is calling using a voice confirmation mode. The voice tags stored for the voice confirmation are stored in a specific “car” library.

Country A vs. Country B

Use different libraries depending on which country the user is in. The given Country Profile may be selected by the user or possibly be chosen automatically when the phone identifies that it is in a particular land. The country profile can then use a specific list for voice activated dialling, for example.

Time Period A vs. Time Period B

The telephone automatically changes the user profile and hence the list of names for VAD at the end of the working day. Alternatively the phone can be programmed to change profile after a pre-set time interval (e.g. in 2 hours' time).

User A vs. User B

If more than one person uses the telephone then they can have their own profiles with their own lists of names. This gives additional advantages as the two users will record their lists of names independently and may well have the same names for different people. Any possible confusion can be avoided by selecting the correct profile. The different users will also have different pre-recorded commands for voice answering etc (e.g. yes, no, answer,) which will be associated with the profile. Enabling the use of specific lists for specific profiles will enable multiple users to use a telephone because each user will be able to store their own voice tag library which is associated only with their specific profile.

Two Telephone Lines From One Phone

This can be associated with any of the situations listed above (e.g. one line for home, one for work or one subscription in Country A another in Country B). The relevant profile can be chosen by the user or selected automatically when changing lines. The voice activation commands relating to the different lines, and possibly different operators, are then automatically loaded into the DSP memory from the library concerned.

It will be readily appreciated that the use of profile-specific libraries of stored voice tags is not only applicable for use on mobile telephones; voice activation of functions in other electronic devices such as PCs, hand held computers and communicators is also possible. Multiple stored voice tag libraries can enable multiple users to use voice activated commands, by allowing each user to pre-record a voice tag library. WAP (wireless application protocol) enabled mobile telephones are also suitable for use in such a way.

It will therefore be appreciated that an electronic device embodying the present invention can usefully store a large number of voice tags, but can retain the speed and cost advantages of having a digital signal processor containing a small amount of memory.

1. An electronic device comprising:
control means for providing the device with a plurality of selectable operating modes, the operating modes defining respective sets of operating parameters for functions of the device;
voice detection means for receiving an input voice signal and for providing voice activation of at least one function of the device, the voice detection means being operable to compare an input voice signal with a library of stored voice signals and to output a control signal on the basis of that comparison,
wherein the stored voice signals are stored by at least one user of the device, and wherein each operating mode of the device has an associated library of stored voice signals for use by the voice detection means when the operating mode concerned is selected.

2. An electronic device having a plurality of user selectable operating modes, each operating mode defining a set of operating parameters for the device, and having at least one voice activated function which is responsive to an input voice signal, wherein reference voice signals are stored in the device by at least one user of the device and wherein the reference voice signals are stored in groups, each of which relates to a specific operating mode of the device.

3. A device as claimed in claim 1 or 2, being a mobile telephone and having a voice activated dialling function for dialling called numbers in response to a voice input from a user, the groups of reference voice signals including references to intended called numbers.

4. A device as claimed in claim 1 or 2, being a mobile telephone, and wherein the reference voice signals relate to specific functions of the telephone.

5. A device as claimed in claim 1 or 2, being a mobile telephone, wherein at least one operating mode is defined by at least one user of the telephone, the reference signal group associated with that operating mode also being defined by the user.

6. A method of operating an electronic device which has a plurality of operating modes for defining operating parameters of the device, and which has at least one voice activated function, the method comprising:
storing reference voice signals in groups;
associating the said groups with respective operating modes of the device; and
using an associated group of reference signals for voice signal matching in a chosen operating mode.

7. A method as claimed in claim 6, wherein the device is a mobile telephone.

8. A method as claimed in claim 7, wherein each operating mode defines a respective list of voice references to potential dialled numbers, the voice references being compared with an input voice signal to determine the number to be dialled by the telephone.
